(19) United States
(12) Patent Application Publication
(10) Pub. No.: US 2023/0191940 A1
(43) Pub. Date: Jun. 22, 2023

(54) POWER SUPPLY SYSTEM FOR POWERING A HOME

(71) Applicant: Our Next Energy, Inc., Novi, MI (US)

(72) Inventor: Mujeeb Ijaz, West Bloomfield, MI (US)

(21) Appl. No.: 18/083,061

(22) Filed: Dec. 16, 2022

Related U.S. Application Data
(60) Provisional application No. 63/265,830, filed on Dec. 21, 2021.

(51) Int. Cl. B60L 55/00; B60L 58/14; B60L 50/60; H01M 10/46; H02J 7/00

(52) U.S. Cl. CPC B60L 55/00; B60L 58/14; B60L 50/60; H01M 10/465; H02J 7/0047; H02J 7/0063; H02J 7/00712

(57) ABSTRACT

A power supply system for an electric vehicle that includes a battery pack, an inverter electrically coupled to the battery pack, and one or more switches disposed between the inverter and a motor of said electric vehicle. The inverter is operable, by operation of the one or more switches, in a first mode of operation to power a motor of the electric vehicle and in a second mode of operation to an entire load of the home up to a defined power limit of the battery pack.

### TECHNICAL FIELD

The disclosure relates generally to systems, methods and computer programs for supplying power to a home and more specifically, to systems, methods and computer programs for operating an electric vehicle to provide a home with all of its power needs.

### BACKGROUND

Current electric vehicles may be equipped with rechargeable batteries (for example, secondary batteries such as lithium-ion or nickel metal hydride batteries) that may have large capacities and may provide a power source a transmission system.

As electric vehicles grow in popularity, it has been suggested that they be used for purposes other than transportation, for example, as a nighttime power supply or as a source of emergency power.

### BRIEF SUMMARY

The illustrative embodiments provide a system, method, and computer readable media. In one aspect, a power supply system is provided for use with an electric vehicle such as a micro-grid utility vehicle and a home. The power supply system may comprise a battery pack disposed at a first portion of a micro-grid utility vehicle, an inverter disposed at another portion the micro-grid utility vehicle and electrically coupled to the battery pack and one or more switches disposed between the inverter and a motor of said micro-grid utility vehicle. The inverter may be operable, by operation of the one or more switches, in a first mode of operation to power a motor of the micro-grid utility vehicle and in a second mode of operation to power a home. The inverter may be configured to be connected to a meter of the home in said second mode of operation and to convert a direct current (DC) of the battery pack to an alternating current (AC), in said second mode of operation, to power an entire load of the home up to a defined power limit of the battery pack. The inverter may further be operable in a third mode of operation as a docking station to charge or provide power to one or more external standalone devices. Further, an example of the micro-grid utility vehicle may be a side-by-side electric vehicle. Other technical features may be readily apparent to one skilled in the art from the following figures, descriptions, and claims.

In another aspect, a method of operating a power supply system may be provided. The method may include providing a micro-grid utility vehicle having a battery pack disposed at a first portion of the micro-grid utility vehicle, an inverter disposed at another portion the micro-grid utility vehicle and electrically coupled to the battery pack and one or more switches disposed between the inverter and a motor of said micro-grid utility vehicle. The inverter may be operated in a first mode of operation, using the one or more switches, to power a motor of the micro-grid utility vehicle, and in a second mode of operation, using the one or more switches, to power an entire load of the home up to a defined power limit of the battery pack. This may be achieved by connecting the inverter to a meter of the home and converting a direct current (DC) of the battery pack to an alternating current (AC) for said meter, wherein a need to back feed a power from the battery pack directly to a distribution box of said home and thus disconnect said distribution box from the grid for safety in said second mode of operation is eliminated.

In yet another aspect, a non-transitory computer readable storage medium may be provided. The non-transitory computer readable storage medium may store program instructions which, when executed by a processor, causes the processor to perform a procedure that includes the steps of operating the inverter of a micro-grid utility vehicle in a first mode of operation, based on the one or more switches, to power a motor of the micro-grid utility vehicle, operating the inverter in a second mode of operation, based on the one or more switches, to power an entire load of the home up to a defined power limit of the battery pack by converting a direct current (DC) of the battery pack to an alternating current (AC) for said meter.

### BRIEF DESCRIPTION OF THE DRAWINGS

To easily identify the discussion of any particular element or act, the most significant digit or digits in a reference number refer to the figure number in which that element is first introduced. Certain novel features believed characteristic of the power supply system are set forth in the appended claims. The power supply system itself, however, as well as a preferred mode of use, further non-limiting objectives and advantages thereof, will best be understood by reference to the following detailed description of the illustrative embodiments when read in conjunction with the accompanying drawings, wherein:

FIG. 1 depicts a block diagram of a power supply environment including a network of data processing systems in which illustrative embodiments may be implemented.

FIG. 2 depicts a block diagram of a data processing system in which illustrative embodiments may be implemented.

FIG. 3 depicts a block diagram of a drivetrain and power supply components in accordance with illustrative embodiments.

FIG. 4 depicts a schematic diagram of a power supply environment in accordance with illustrative embodiments.

FIG. 5 depicts an application in accordance with illustrative embodiments.

FIG. 6 depicts a flowchart of a method in accordance with illustrative embodiments.

### DETAILED DESCRIPTION

The illustrative embodiments are directed to a home and electric vehicle energy system that is operable in a plurality of operational modes including at least a mode configured to power an entire electrical load of a home. This may be achieved by the use of an inverter adapted to provide power to both a motor of the electric vehicle such as a micro-grid utility vehicle and the home through a direct connection to a meter of the home. The illustrative embodiments recognize that while existing power supply systems may be configured to provide power to some electrical loads of a home, said existing systems may preclude powering an entire electrical load of the home and may instead be configured to power a subset of the electrical load of the home through a direct connection to a distribution box of the home. This may necessitate the electrical separation of said distribution box from other distribution boxes for safety reasons and thus a disconnection of the distribution box from the grid and the home meter, effectively ensuring that a subset of the electrical load of the house is powered.

The illustrative embodiments provide an inverter 338 (motor-home inverter) that is operable, by operation of the one or more switches, in a first mode of operation to power a motor of the electric vehicle and in a second mode of operation to power the home.

For the clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of systems are used in the figures and the illustrative embodiments. In an actual power supply environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for power supply systems for electric vehicles using a variety of components that can be purposed or repurposed to provide a described operational mode, and such adaptations are contemplated within the scope of the illustrative embodiments.

The illustrative embodiments are described with respect to certain types of devices, steps, applications, processors, problems, and data processing environments only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

The illustrative embodiments described herein are directed to a power supply system 102 for home and electric vehicles. The power supply system 102 may comprise a battery pack 304 disposed at a first portion of a micro-grid utility vehicle, which is hereinafter generally referred to, by way of an example, as a side-by-side electric vehicle 124. Of course, other vehicles of similar size to the size of a conventional side-by-side vehicle and that may be configured to be used with a grid system are contemplated as micro-grid utility vehicles herein. The power supply system 102 may also comprise an inverter 338 disposed at another portion the side-by-side electric vehicle 124 and electrically coupled to the battery pack 304, one or more switches 358 disposed between the inverter 338 and a motor 340 of said side-by-side electric vehicle 124. The inverter 338 may be operable, by operation of the one or more switches 358, in a first mode of operation to power a motor 340 of the side-by-side electric vehicle 124 and in a second mode of operation to power the home 362 and the inverter may be configured to be connected to a meter 128 of the home 362 in said second mode of operation and to convert a direct current (DC) of the battery pack to an alternating current (AC), in said second mode of operation, to power an entire load of the home 362 up to a defined power limit of the battery pack 304.

One or more embodiments may include one or more processors included in or outside an on-board or external computer system to monitor and manage the modes of operation of the inverter 338 and/or forecast a power requirement of the home 362 and/or determine a grid power availability for the home 362 to ensure provision of continuous electrical power for an entire load of the home via a battery of the power supply system 102.

As used herein, a sensor is a sensor device that can be a system, an apparatus, software, hardware, a set of executable instructions, an interface, a software application, a transducer and/or various combinations of the aforementioned that include one or more sensors utilized to indicate, respond to, detect and/or measure a physical property and generate data concerning the physical property.

The battery pack may comprise a traction battery and may also comprise hybrid range extender battery. Those having skill in the art appreciate that other types of battery configuration may be used to provide power in the embodiments described herein and, thus, the recitation of a certain configurations is not intended to be limiting. As discussed hereinafter, a battery management system (BMS) or other controller may control the operation of the inverter 338 and/or the charging and discharging of the battery pack so that the power supply system 102 may be operated in an efficient and power saving mode. One or more embodiments described herein may include an on-board and/or external computer system that estimates electrical power requirements of the home and/or states of health (SOH) and states of charge (SOC) of the battery pack to determine if the side-by-side electric vehicle 124 may safely provide power without interruption. In one or more embodiments, the homes have a power requirement of less than 60 kW and the side-by-side electric vehicle 124 possesses a power limit of about 100 kW(e.g., 90-110 kW, or 80-120 kW). One feature of the BMS or on-board or external computer system may be to estimate the state-of-charge (SOC) of a battery pack as it to efficiently maintain the SOC of the battery packs, via, for example a solar panel 360, to ensure that the battery pack is ready for any operational mode of the inverter 338. For example, the battery may not be discharged below a defined percentage of its capacity (e.g., 60% or 70%) at any time or at a defined or forecasted time during which a second mode of operation of the inverter is likely. This may ensure the availability of enough reserve power to sustain an entire load of the home when grid power is unavailable. Further, in another example, by determining a state of charge of one or more cells of the battery pack to be below a threshold SOC, one or more other cells of the battery pack may be independently charged to ensure availability of enough power in the battery pack to power an entire load of the home. Even further, a subset of cells or battery modules of the battery pack may be reserved for one operational mode and another subset of cells may be reserved for another operational mode that is different from said one operational mode.

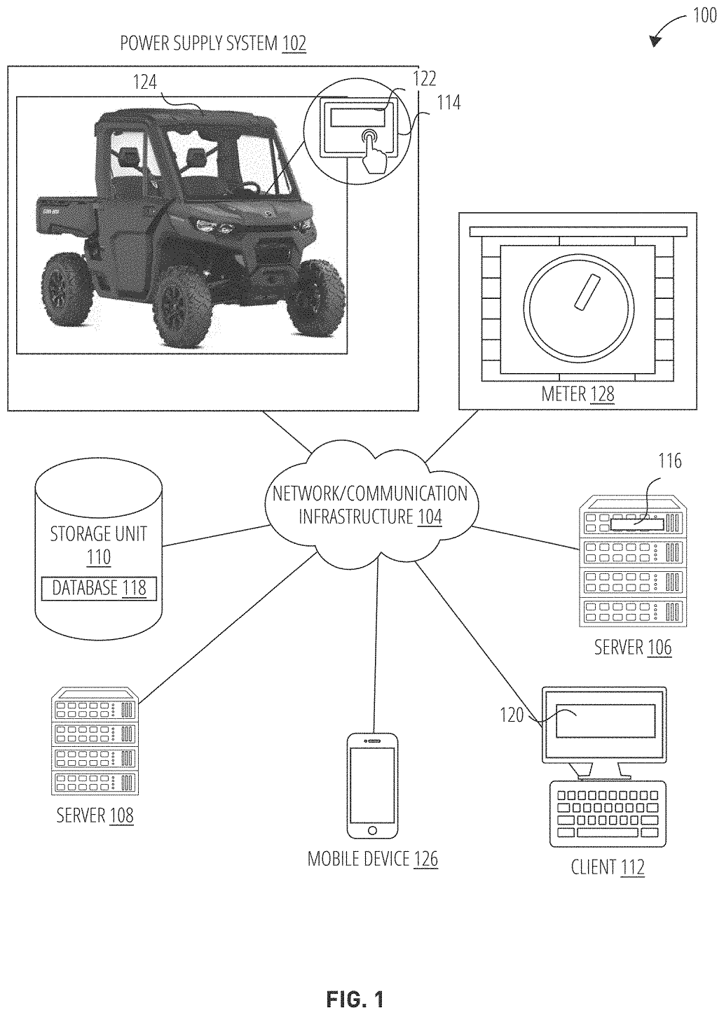

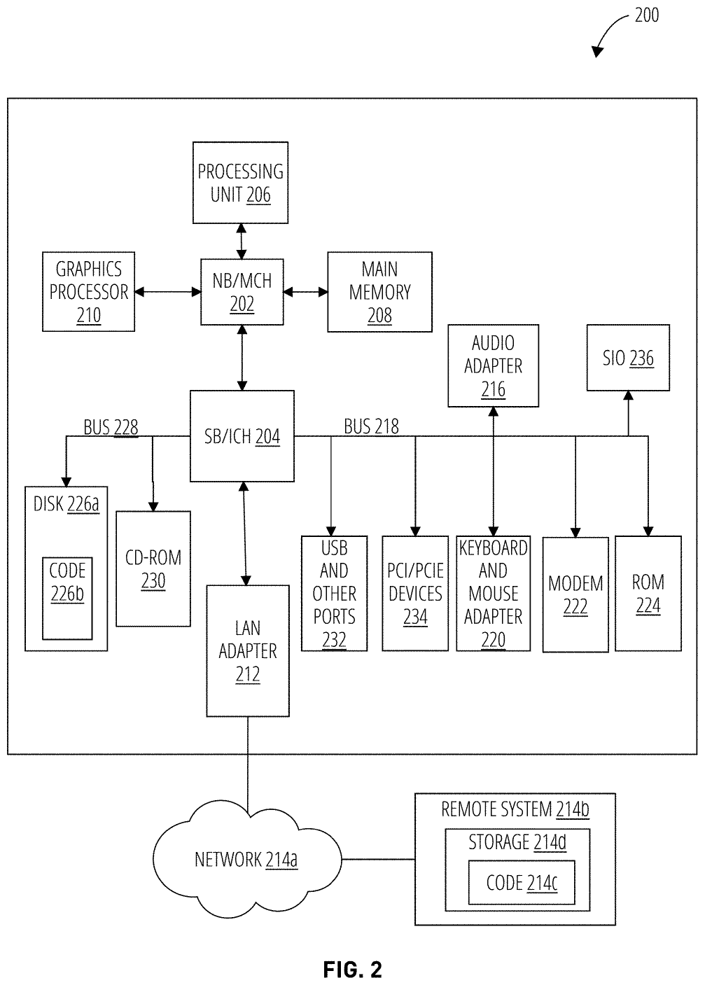

With reference to the figures and in particular with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a power supply environment 100 in which illustrative embodiments may be implemented. Power supply environment 100 includes network/communication infrastructure 104. Network/communication infrastructure 104 may be the medium used to provide communications links between various devices, databases and processors connected together within the power supply environment 100. Network/communication infrastructure 104 may include connections, such as wire, wireless communication links, or fiber optic cables. The environment may include a power supply system 102 and clients or servers configured to perform one or more processes herein. The power supply system 102 includes a battery pack 304 and an inverter 338 disposed in side-by-side electric vehicle 124. A dashboard 114 and a dashboard application 122 may be part or separate from power supply system 102 or the side-by-side electric vehicle 124. The dashboard application 122 may be operable to control parameters of the power supply system 102 including, for example, modes of operations of the inverter 338.

Clients or servers are only example roles of certain data processing systems connected to network/communication infrastructure 104 and are not intended to exclude other configurations or roles for these data processing systems or to imply a limitation to a client-server architecture. Server 106 and server 108 couple to network/communication infrastructure 104 along with storage unit 110. Software applications, such as embedded software applications may execute on any computer or processor or controller in power supply environment 100. Client 112, dashboard 114, mobile device 126 may also be coupled to network/communication infrastructure 104. Client 112 may be a remote computer with a display. A data processing system, such as server 106 or server 108, or clients (client 112, dashboard 114) may contain data and may have software applications or software tools executing thereon.

As another example, an embodiment can be distributed across several data processing systems and a data network as shown, whereas another embodiment can be implemented on a single data processing system within the scope of the illustrative embodiments. Data processing systems (server 106, server 108, client 112, dashboard 114, mobile device 126) also represent example nodes in a cluster, partitions, and other configurations suitable for implementing one or more processes described herein.

Client application 120, dashboard application 122, or any other application such as server application 116 may implement an embodiment described herein. Any of the applications can use data from power supply system 102 and to partially or fully perform one or more processes described herein. The applications may also obtain data from storage unit 110 for power supply purposes. The applications can also execute in any of data processing systems (server 106 or server 108, client 112, dashboard 114, mobile device 126).

Server 106, server 108, storage unit 110, client 112 , dashboard 114, mobile device 126 may couple to network/communication infrastructure 104 using wired connections, wireless communication protocols, or other suitable data connectivity.

In the depicted example, server 106 may provide data, such as load requirements of individual electrical appliances in the home, boot files, operating system images, and applications to client 112, and dashboard 114 or mobile device 126. Client 112, dashboard 114 and mobile device 126 may be clients to server 106 in this example. Client 112, and dashboard 114 or some combination thereof, may include their own data, boot files, operating system images, and applications. Power supply environment 100 may include additional servers, clients, and other devices that are not shown.

Network/communication infrastructure 104 may represent a collection of networks and gateways that use Controller Area Network (CAN) bus communication, Transmission Control Protocol/Internet Protocol (TCP/IP) and other protocols to communicate with one another. Of course, power supply environment 100 also may also utilize a number of different types of networks, such as for example, an intranet, a local area network (LAN), or a wide area network (WAN). FIG. 1 is intended as an example, and not as an architectural limitation for the different illustrative embodiments.

With reference to FIG. 2, this figure depicts a block diagram of a data processing system in which illustrative embodiments may be implemented. Data processing system 200 is an example of a computer, such as client 112, dashboard 114, server 106, server 108, or mobile device 126 in FIG. 1, or another type of device in which computer usable program code or instructions implementing the processes may be located for the illustrative embodiments.

Data processing system 200 is described as a computer only as an example, without being limited thereto. Implementations in the form of other devices, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCI/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices.

Instructions for the operating system, and applications or programs, (such as server application 116, or client application 120 or dashboard application 122) are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. In addition, the processes of the illustrative embodiments may be applied to a multiprocessor data processing system.

A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

The depicted examples in FIG. 1 and FIG. 2 and above-described examples are not meant to imply architectural limitations.

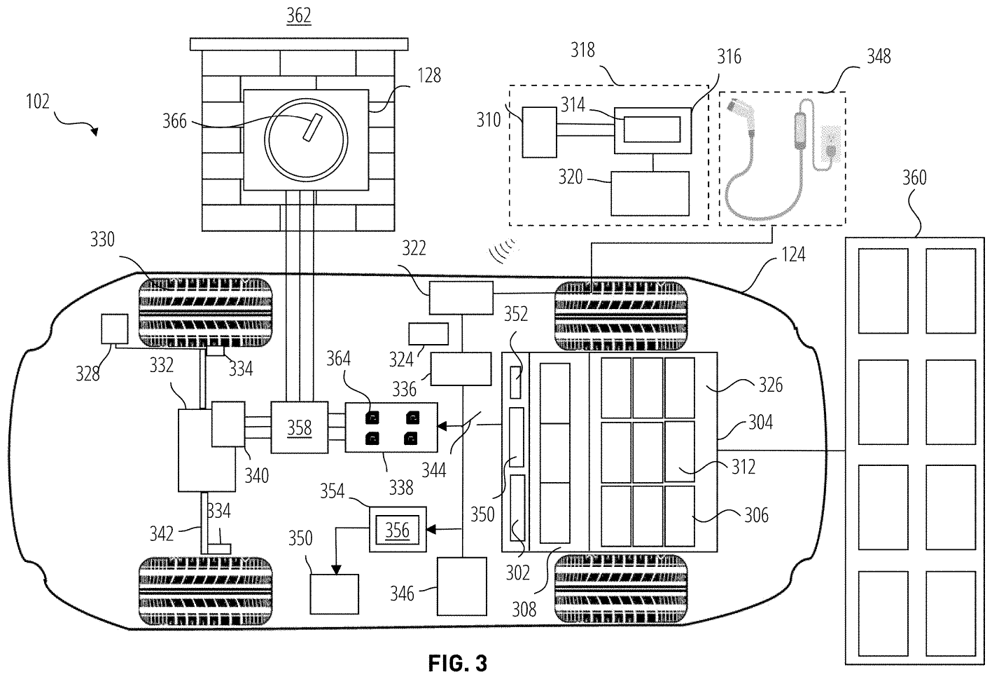

With reference to FIG. 3 an example schematic diagram of a side-by-side electric vehicle and power supply system 102 in which illustrative embodiments may be implemented are shown.

The power supply system 102 may apply to all electrified/electric micro-grid utility or side-by-side vehicles, including, but not limited to, side-by-side battery electric vehicles (BEV's) and side-by-side plug-in hybrid electric vehicles configured to utilize rechargeable electric batteries as their main or only source of energy to power their drive systems propulsion or that possess an all-electric drivetrain.

The power supply system 102 may be fully or partially located in the side-by-side electric vehicle 124 which may comprise one or more motors 340 mechanically connected to a transmission 332. The transmission 332 may be mechanically connected to a drive shaft 342 that is mechanically connected to the wheels 328. The motor 340 may provide propulsion and deceleration capability.

More specifically, the power supply system 102 of the side-by-side electric vehicle 124 may comprise a battery pack 304 disposed at a first portion of the side-by-side electric vehicle 124, the inverter 338 disposed at another portion the electric vehicle and electrically coupled to the battery pack 304, one or more switches 358 disposed between the inverter and a motor 340 of said electric vehicle. The inverter 338 may be operable, by operation of the one or more switches 358, in a first mode of operation to power a motor of the electric vehicle and in a second mode of operation to power the home. In the first mode of operation, the inverter 338 may be configured to convert a direct current (DC) of the battery pack to alternating current (AC) of variable frequency to drive said motor. The AC signal may be a three-phase output voltage used to drive a rotor of the motor. The same inverter may be configured to be connected to a meter 128 of the home in said second mode of operation and to convert a direct current (DC) of the battery pack 304 to an alternating current (AC), to power an entire load of the home up to a defined power limit of the battery pack 304. The one or more switches 358 may be contactors and may be controlled by a processor such as a processor of the BMS or other internal or external processor to bring about a changeover from one mode of operation to another mode of operation. In some embodiments, the meter 128 may be part of the power supply system 102 and may be provided with automatic switch 366 that is configured to determine or sense an availability of a grid power and to cause, responsive to determining that said grid power is unavailable, a processor to change the mode of operation of the inverter from the first mode of operation or any other mode of operation to the second mode of operation.

The inverter 338 may comprise a plurality of transistors 364 that are configured to be selectively switched by a microcontroller to produce one or more output AC frequencies and one or more output AC voltages of the inverter for the first mode of operation and the second mode of operation. The plurality of transistors comprises insulated-gate bipolar transistors (IGBTs) or metal-oxide-semiconductor field-effect transistors (MOSFETs), Silicon Carbide transistors, or gallium nitride (GaN) transistors. In the case of the second mode of operation, the output AC frequency may be a constant frequency equal to a standard frequency of power provided by a grid 406 in the location of the home (e.g., a value between 50-60 Hz, e.g. 60 Hz in the United States of America or 50 Hz in the United Kingdom) and the output AC voltage provided to the meter 128 may be a Line-to-Line Voltage (of e.g. 208V for homes in the United States of America) which Line-to-Line Voltage may be a voltage between phases of the three-phase output of the inverter. The 208V three-phase output may provide a 120V single-phase voltage (i.e., 208V/\sqrt{3}) from Line(hot) to Neutral for said home. Of course, other three-phase voltages and corresponding single-phase voltages may be obtained for other countries in light of the descriptions.

In some embodiments, the battery pack 304 comprises a traction battery 308 and a range extender battery 326. One or more contactors 344 may isolate the battery pack 304 from other components when opened and connect the battery pack 304 to other components when closed. In addition to providing energy for propulsion, the battery pack 304 may provide energy for other vehicle electrical systems. The system may include a DC-DC converter module 354 configured to step up or step-down voltages. The auxiliary DC-DC converter module 352 and/or bi-directional DC-DC converters (not shown) between traction and range extender batters may form a part of or be separate from the DC-DC converter module 354. In addition, the battery pack 304 may have an on-board AC-DC charger 302 to convert AC voltages to DC. In some embodiments, the auxiliary battery 350 may be placed within the power supply system (inside the traction battery 308) instead of outside the power supply system. Thereby, additional contactors 344 in the battery pack 304 may can be controlled, for example kept closed, even if power is lost.

The battery pack assembly may also have a cell-to-pack configuration. For example, a battery pack configuration may include cells directly placed in an enclosure without the use of separate modules, with the enclosure also housing other hardware such as, but not limited to the Auxiliary DC-DC converter module 352, the system controller 324 (such as a battery management system (BMS)), the power conversion module 336, battery thermal management system (cooling system and electric heaters) and the contactors 344. However, other configurations may be available as this is not intended to be limiting. By minimizing a volume and size of the converters a consolidated arrangement with reduced heating and efficient power conversion may be provided for the side-by-side electric vehicle 124.

The inverter 338 may also be electrically connected to the motor 340 and may provide the ability to transfer energy between the battery pack 304 and the motor 340. For example, a traction or range-extender battery may provide a DC voltage while the motor 340 may operate using a three-phase AC current. The inverter 338 may convert the DC voltage to a three-phase AC current for use by the motor 340 in a first mode of operation 510. However, the inverter 338 may additionally convert the DC voltage to a constant frequency AC output for a meter 128 of the home 362.

The battery pack 304 may be charged by a charging system such as a wireless vehicle charging system 318 or a plug-in charging system 348. However, a solar panel 360 may also be used to charge the battery pack 304. The solar panel 360 may comprise a plurality of panels stacked to proving charged to one or more cells or modules of the battery pack at one or more defined charging rates. The wireless vehicle charging system 318 may include an external power source 310. The external power source 310 may be a connection to an electrical outlet. The external power source 310 may be electrically connected to electric vehicle supply equipment 316 (EVSE). The electric vehicle supply equipment 316 may provide an EVSE controller 314 to provide circuitry and controls to regulate and manage the transfer of energy between the external power source 310 and the side-by-side electric vehicle 124. The external power source 310 may provide DC or AC electric power to the electric vehicle supply equipment 316. The electric vehicle supply equipment 316 may be coupled to a transmit coil 320 for wirelessly transferring energy to a receiver 322 of the vehicle 124 (which in the case of a wireless vehicle charging system 318 is a receive coil). The receiver 322 may be electrically connected to a charger or on-board power conversion module 350. The receiver 322 may be located on an underside of the side-by-side electric vehicle 124.

In the case of a plug-in charging system 348, the receiver 322 may be a plug-in receiver/charge port and may be configured to charge the battery pack 304 upon insertion of a plug-in charger. The power conversion module 336 may condition the power supplied to the receiver 322 to provide the proper voltage and current levels to the battery pack 304. The power conversion module 336 may interface with the electric vehicle supply equipment 316 to coordinate the delivery of power to the side-by-side electric vehicle 124.

One or more wheel brakes 334 may be provided for decelerating the side-by-side electric vehicle 124 and preventing motion of the side-by-side electric vehicle 124. The wheel brakes 334 may be hydraulically actuated, electrically actuated, or some combination thereof. The wheel brakes 334 may be a part of a brake system 328. The brake system 328 may include other components to operate the wheel brakes 334. For simplicity, the figure depicts a single connection between the brake system 328 and one of the wheel brakes 334. A connection between the brake system 328 and the other wheel brakes 332 is implied. The brake system 328 may include a controller to monitor and coordinate the brake system 328. The brake system 328 may monitor the brake components and control the wheel brakes 334 for vehicle deceleration. The brake system 328 may respond to driver commands and may also operate autonomously to implement features such as stability control. The controller of the brake system 328 may implement a method of applying a requested brake force when requested by another controller or sub-function. FIG. 3 is intended as an example, and not as an architectural limitation for the different illustrative embodiments.

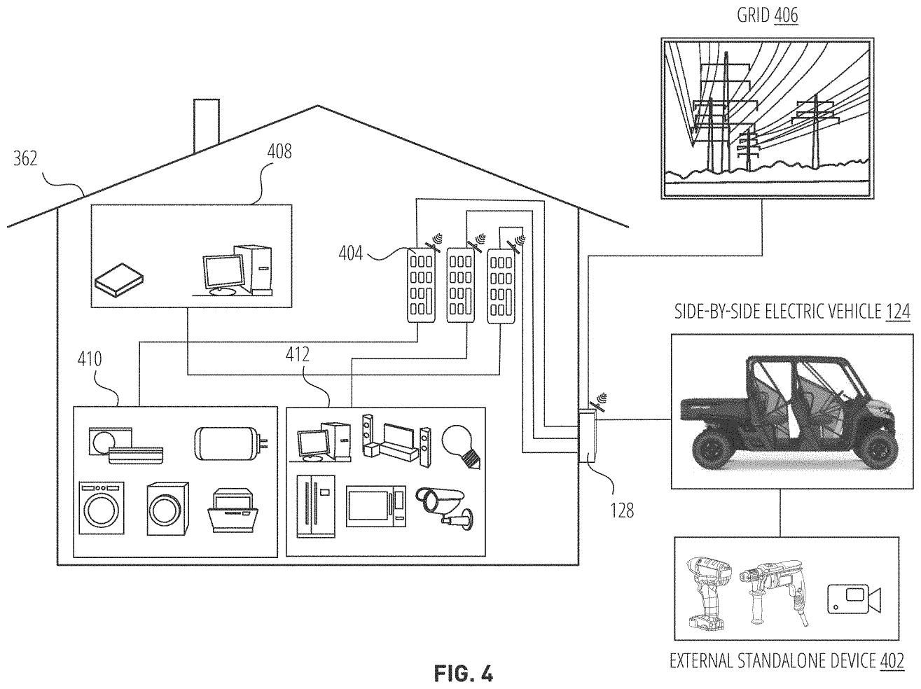

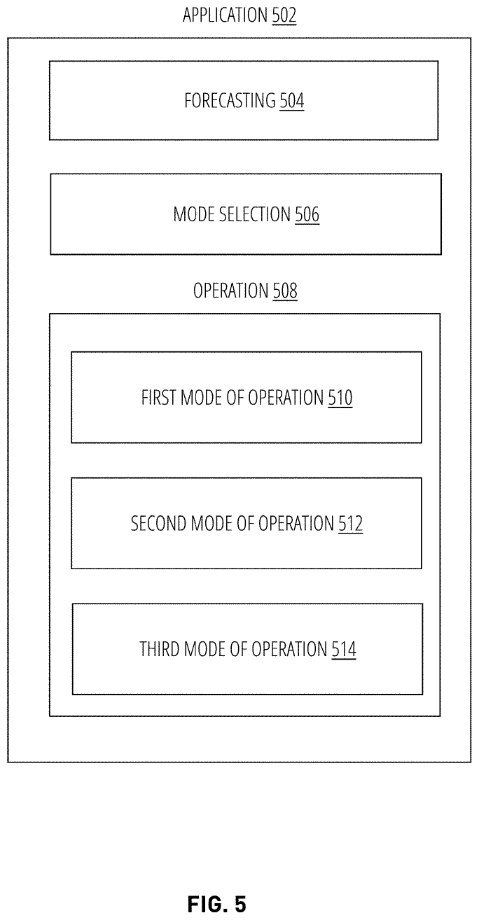

With reference to FIG. 5 and FIG. 4, the power supply system 102 and an application 502 of the power supply system 102 will be further described. The application 502 may be embodied as any of server application 116, client application 120 or dashboard application 122.

Most homes have a power requirement of, for example, 60 kW or less. By defining a power limit of the battery pack 304 to be well above 60 kW (e.g., about 100 kW or more), an entire electrical load of the home 362 such as electrical load 408, first electrical load 410 and second electrical load 412 may be powered through the meter 128 without a need to disconnect any distribution box for safety reasons. Further, the meter 128 and/or distribution boxes 404 may be a smart device that are configured to broadcast a maximum power requirement of the home and/or a power requirement for individual electrical loads in the home 362 for use in forecasting 504, by application 502, a current, or future power requirement of the home 362. By forecasting 504 a power requirement of the home 362, application 502 may configure a processor of the BMS or other microcontroller of the power supply system 102 to select a mode for operation the inverter 338 (mode selection 506) responsive to which said inverter 338 may be operated in a first mode of operation 510, a second mode of operation 512 or even a third mode of operation 514 or any other suitable mode of operations. Thus, in addition to the first mode of operation 510 and the second mode of operation 512, a third mode of operation 514 may be possible wherein the power supply system 102 may serve as a docking station for charging or providing power to external standalone devices 402 such as power tools. Further, by coupling the batter pack of the power supply system to a solar panel, the battery pack may be recharged when needed to provide a sufficient SOC of the battery pack for one or more modes of operation.

A dashboard 114 or other user interface of the power supply system 102 may be configured to display information about a state of charge (SOC) and/or state of health (SOH) of batteries of the battery pack 304. Based on said information, a decision to allow operation of the inverter 338 in one or another mode of operation may be made. For example, by determining that the battery pack has sufficient charge to provide the home 362 with its entire power requirement for 5 hours, the inverter may be operated in the second mode of operation 512. Further, through real time information about the SOC and/or SOH, the user interface may further display information about a remaining time for providing continuous power to the home before the battery is discharged.

In the first mode of operation 510, a variable speed the motor may be achieved by varying a frequency of the alternating current produced from a direct current of the battery pack. Conversely, in the second mode of operation 512 wherein the output AC frequency of the inverter is kept constant at a value between 50-60 Hz, the constant frequency may be achieved based on an appropriate timing of a switching operation the plurality of transistors. Further, in said second mode of operation 512, the output AC voltage of the inverter may be set to the desired value based on a switching frequency of pulses of the DC signal from the battery pack. More specifically, the inverter may be operated to provide different AC output based on pulse width modulation (PWM) of the DC. By switching the transistors 364 on and off very rapidly, the output voltages may be constructed by mixing short bursts of positive and negative volts in varying amounts to give an average voltage that follows a sine wave/sinusoidal shape. For example, a sine wave of current may be generated by a series of DC pulses where the first has a very short ‘on’ period, followed by a longer on period, then longer until the widest pulse appears in the center of the positive sine wave, then smaller until the DC is inverted, and the same pattern of pulses generate the negative part of the sine wave. By controlling the duration of the sine wave, a defined frequency may be set for the second mode of operation 512. By controlling the pattern of the pulses, a defined AC voltage may be obtained.

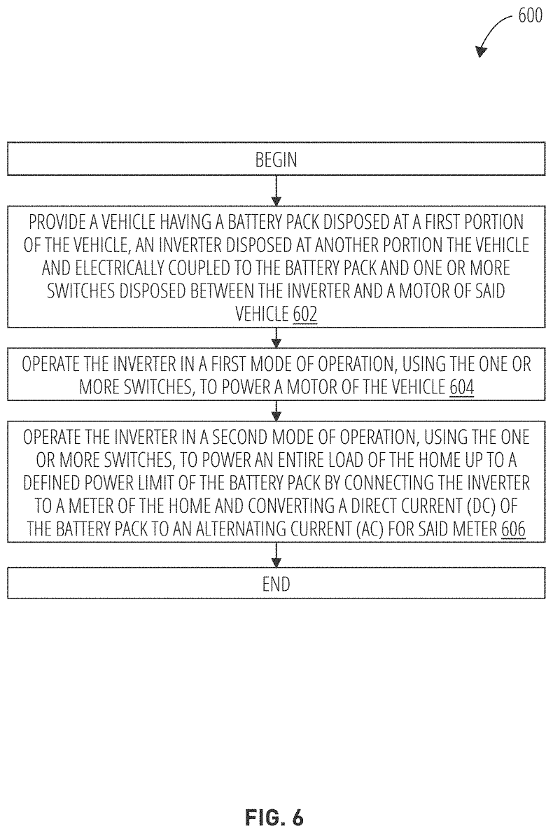

FIG. 6 shows a flowchart of a method according to illustrative embodiments. In step 602, a vehicle having a battery pack disposed at a first portion of the vehicle, an inverter disposed at another portion the vehicle and electrically coupled to the battery pack and one or more switches disposed between the inverter and a motor of the vehicle is provided. In step 604, method 600 operates the inverter in a first mode of operation 510, by connecting one or more switches to a motor of the vehicle, to power said motor. A frequency of the inverter output may be varied to produce a variable speed for the motor and thus the transmission of the vehicle. The inverter output may be a three-phase output. In step 606, method 600 operates the inverter in a second mode of operation 512, by connecting said one or more switches to a meter 128, or a to conduit for connection to the meter, to power an entire load of the home up to a defined power limit of the battery pack. In said second mode, a frequency of the output may be kept constant. The three-phase output may be adapted for use by the home 362 by ensuring that the three-phase output voltage is configured to provide a single-phase voltage that is compatible with the standard grid line voltage of the country or location of the home 362 (typically 120 or 240 VAC at the distribution level). Further, in step 606, the method 600 may preclude an ability to operate the inverter in said second mode of operation, responsive to determining that a power requirement of the home exceeds a threshold available battery power. Step 606 may also determine that the home has a power requirement less than 60 kW, prior to operating the inverter in said second mode of operation, wherein the defined power limit of the battery pack is greater than 60 kW. In the method 600, a third mode of operation 514 may optionally be available wherein the inverter output may serve as a docking station for external standalone devices 402 via an outlet (not shown). Other technical features may be readily apparent to one skilled in the art from the figures, descriptions, and claims.

Thus, a system, method, and computer program product are provided in the illustrative embodiments for operating an inverter of a power supply system for a home and a vehicle. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, a controller area network (CAN), the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A power supply system for an electric vehicle, comprising:
a battery pack disposed at a first portion of an electric vehicle;
an inverter disposed at another portion the electric vehicle and electrically coupled to the battery pack;
one or more switches disposed between the inverter and a motor of said electric vehicle;
wherein the inverter is operable, by operation of the one or more switches, in a first mode of operation to power a motor of the electric vehicle and in a second mode of operation to power a home;
wherein the inverter is configured to be connected to a meter of the home in said second mode of operation and to convert a direct current (DC) of the battery pack to an alternating current (AC), in said second mode of operation, to power an entire load of the home up to a defined power limit of the battery pack.

2. The power supply system of claim 1, wherein the electric vehicle is a micro-grid utility vehicle.

3. The power supply system of claim 1, further comprising:
a plurality of transistors located in the inverter and configured to be selectively switched by a microcontroller to produce an output AC frequency and an output AC voltage of the inverter for the first mode of operation and the second mode of operation.

4. The power supply system of claim 3, wherein the plurality of transistors is selected from the group consisting of insulated-gate bipolar transistors (IGBTs), metal-oxide-semiconductor field-effect transistors (MOSFETs), Silicon Carbide transistors, and gallium nitride (GaN) transistors.

5. The power supply system of claim 3, wherein in the second mode of operation, the output AC frequency of the inverter is kept constant at a value between 50-60 Hz, based on a timing of a switching operation the plurality of transistors.

6. The power supply system of claim 3, wherein in the second mode of operation, an output AC voltage of the inverter is set to a value between 100 and 280V, based on a switching frequency of pulses of the DC.

7. The power supply system of claim 1, wherein the power supply system is configured to automatically switch from said first mode of operation to said second mode of operation based on information about available grid power.

8. The power supply system of claim 1, wherein the power supply system is configured to power the entire load of the home without direct connection to any distribution box of a plurality of distribution boxes of the home.

9. The power supply system of claim 1, wherein the inverter is further operable in a third mode of operation as a docking station to charge or provide power to one or more external standalone devices.

10. The power supply system of claim 1, wherein the battery pack is coupled to a solar panel that recharges the battery pack.

11. The power supply system of claim 1, wherein the inverter is configured to convert a direct current (DC) of the battery pack to alternating current (AC) of variable frequency to drive said motor.

12. The power supply system of claim 1, wherein the one or more switches are one or more contactors and wherein said one or more contactors are controlled by a processor of the power supply system.

13. The power supply system of claim 1, wherein the defined power limit is about 100 kW.

14. The power supply system of claim 1, further comprising:
an automatic switch provided with the meter of the home;
wherein said automatic switch is configured to determine an availability of a grid power and to cause, responsive to determining that said grid power is unavailable, an automatic changeover of the operation of the inverter from the first mode of operation or any other mode of operation to the second mode of operation.

15. The power supply system of claim 1, further comprising:
a user interface configured to display information about a state of charge (SOC) and/or state of health of batteries of the battery pack.

16. The power supply system of claim 15, wherein the user interface further displays information about a remaining time for providing power continuously to the home.

17. A method of operating a power supply system comprising:
providing an electric vehicle having a battery pack disposed at a first portion of the electric vehicle, an inverter disposed at another portion the electric vehicle and electrically coupled to the battery pack and one or more switches disposed between the inverter and a motor of said electric vehicle;
operating the inverter in a first mode of operation, using the one or more switches, to power a motor of the electric vehicle;
operating the inverter in a second mode of operation, using the one or more switches, to power an entire load of the home up to a defined power limit of the battery pack by connecting the inverter to a meter of the home and converting a direct current (DC) of the battery pack to an alternating current (AC) for said meter;
wherein a need to back feed a power from the battery pack directly to a distribution box of said home in said second mode of operation is eliminated.

18. The method of claim 23, wherein the defined power limit of the battery pack is about 100 kW and the electric vehicle is a micro-grid utility vehicle.

19. The method of claim 17, further comprising:
operating the invertor in the second mode of operation at a constant output AC frequency of between 50-60 Hz.

20. The method of claim 17, further comprising:
operating the invertor in the second mode of operation at an output AC voltage of 208V.

21. The method of claim 17, wherein the power supply system automatically switches from the first mode of operation or any other mode of operation to the second mode of operation responsive to determining that a grid power is unavailable.

22. The method of claim 17, further comprising:
ending an ability to operate the inverter in said second mode of operation, responsive to determining that a power requirement of the home exceeds a threshold battery power.

23. The method of claim 17, further comprising:
determining that the home has a power requirement less than 60 kW, prior to operating the inverter in said second mode of operation;
wherein the defined power limit of the battery pack is greater than 60 kW.

24. A non-transitory computer readable storage medium storing program instructions which, when executed by a processor, causes the processor to perform a procedure comprising the steps of:
operating the inverter of an electric vehicle in a first mode of operation, using the one or more switches, to power a motor of the electric vehicle;
operating the inverter in a second mode of operation, using the one or more switches, to power an entire load of the home up to a defined power limit of the battery pack by converting a direct current (DC) of the battery pack to an alternating current (AC) for said meter;
wherein the inverter is connected to a meter of the home, and
wherein a need to back feed a power from the battery pack directly to a distribution box of said home in said second mode of operation is eliminated.

25. A power supply system for an electric vehicle, comprising:
a battery pack disposed in the electric vehicle; and
an inverter disposed in the electric vehicle and electrically coupled to the battery pack;
wherein the inverter is operable, in a first mode of operation to power a motor of the electric vehicle and in a second mode of operation to power a home;
wherein the inverter is configured to be connected to a meter of the home in said second mode of operation and to power an entire load of the home.
